(19) United States
(12) Patent Application Publication
(10) Pub. No.: US 2010/0033986 A1
(43) Pub. Date: Feb. 11, 2010

(54) Light Pipe For Imaging Head of Video Inspection Device

(75) Inventors: Jeffrey C. Schober, Sterling Heights, MI (US); Al Boehnlein, Ypsilanti, MI (US); Jeffrey Miller, Northville, MI (US)

Correspondence Address: HARNESS, DICKEY & PIERCE, P.L.C., P.O. BOX 828, BLOOMFIELD HILLS, MI, 48303, US

(73) Assignee: PERCEPTRON INC., Plymouth, MI (US)

(21) Appl. No.: 12/186,182

(22) Filed: Aug. 5, 2008

(51) Int. Cl. G02B 6/12; G02B 6/00; F21V 7/04

(52) U.S. Cl. 362/555; 385/133; 385/14

(57) ABSTRACT

A light dispersal unit or light pipe for a video imaging device includes a transparent body. The body includes a tubular ring having an outer diameter and a through bore defining an inner diameter. Four equidistantly spaced raised portions are homogenously joined to the tubular ring. The ring has a semi-circular shape corresponding to the outer and inner diameters of the tubular ring. The raised portions each include a slot created between opposed first and second extending portions, the slot having an end wall and opposed first and second slot walls. A rounded end face defines a free end of each of the first and second extending portions facing away from the tubular ring. The rounded end face includes at least two curved portions each having a different radius of curvature.

### FIELD

The present disclosure relates to borescopes and video scopes.

### BACKGROUND

The statements in this section merely provide background information related to the present disclosure and may not constitute prior art.

Borescopes and video scopes used for inspecting visually obscure locations, hereinafter referred to as remote inspection devices, are typically tailored for particular applications. For instance, some remote inspection devices have been tailored for use by plumbers to inspect pipes and drains. Likewise, other types of remote inspection devices have been tailored for use by mechanics to inspect interior compartments of machinery being repaired.

Analog remote inspection devices are known which have hand-held control units using a power source such as a plurality of batteries, with data leads and power lines extending through a flexible cable to a light diffusing/image receiving head. Such devices commonly provide a remote light source to illuminate the area of interest and an imaging device to capture the illuminated image. Images provided by analog signal devices are adequate for many applications, however, where fine image detail is desired digital signal devices can convey greater volumes of data to improve the resolution. To further improve resolution, an increased power light source can also be used, created for example by increasing a quantity of light emitting components. However, increasing the quantity of light emitting components can introduce focal distortion and/or areas where light is not evenly diffused to illuminate a desired object.

### SUMMARY

According to several embodiments of the present disclosure, a light dispersal unit for a video imaging device includes a transparent body having a tubular ring and at least one raised portion homogenously joined to the tubular ring. The at least one raised portion includes a slot created between opposed first and second extending portions having an end wall and opposed first and second slot walls. A rounded end face defining a free end of each of the first and second extending portions faces away from the tubular ring.

According to other embodiments, a light dispersal unit or light pipe for a video imaging device includes a transparent body. The body includes a tubular ring having an outer diameter and a through bore defining an inner diameter. Four equidistantly spaced raised portions are homogenously joined to the tubular ring. The ring has a semi-circular shape corresponding to the outer and inner diameters of the tubular ring. The raised portions each include a slot created between opposed first and second extending portions, the slot having an end wall and opposed first and second slot walls. A rounded end face defines a free end of each of the first and second extending portions facing away from the tubular ring. The rounded end face includes at least two curved portions each having a different radius of curvature.

According to still other embodiments, a video imaging device includes a circuit board having a light emitting diode connected to the circuit board. A transparent light pipe has a tubular ring and at least one raised portion homogenously joined to the tubular ring. The at least one raised portion includes a slot created between opposed first and second extending portions having an end wall and opposed first and second slot walls. A rounded end face defining a free end of each of the first and second extending portions faces away from the tubular ring. A light pipe cap adapted to retain the circuit board and the light pipe having the slot of the light pipe aligned with the light emitting diode so that light emitted by the light emitting diode is received at the slot and by the rounded end face of each of the first and second extending portions.

According to further embodiments, a video imaging device, includes a circuit board having four light emitting diodes connected to the circuit board equidistantly spaced from each other. A transparent light pipe includes a tubular ring having an outer diameter and a through bore defining an inner diameter. Four equidistantly spaced raised portions are homogenously joined to the tubular ring and have a semi-circular shape corresponding to the outer and inner diameters of the tubular ring. The raised portions each include a slot created between opposed first and second extending portions having an end wall and opposed first and second slot walls. A rounded end face defines a free end of each of the first and second extending portions facing away from the tubular ring. The rounded end face includes at least two curved portions each having a different radius of curvature. A light pipe cap adapted to retain the circuit board and the light pipe in a manner which has each slot of the light pipe aligned with one of the light emitting diodes so that light emitted by each light emitting diode is received at the slot and by the rounded end face of each of the first and second extending portions.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of an imager assembly for remote inspection devices of the present disclosure;

FIG. 2 is an assembly view of the component parts of the imager head sub-assembly of FIG. 1;

FIG. 3 is a top plan view of an imager head having a light pipe, cap, and nut of the present disclosure;

FIG. 4 is cross sectional front elevational view taken at section 4 of FIG. 3;

FIG. 5 is a cross sectional front elevational view of area 5 of FIG. 4;

FIG. 6 is a bottom perspective view of a light pipe of the present disclosure;

FIG. 7 is a bottom plan view of the light pipe of FIG. 6;

FIG. 8 is a side elevational view of the light pipe of FIG. 6;

FIG. 9 is bottom perspective view of a light pipe cap of the present disclosure;

FIG. 10 is a front elevational view of the light pipe cap of FIG. 9;

FIG. 11 is a bottom plan view of the light pipe cap of FIG. 9;

FIG. 12 is a top plan view of a cap/circuit board assembly of the present disclosure;

FIG. 13 is a cross sectional elevational view taken at section 13 of FIG. 12;

FIG. 14 is a cross sectional elevational view taken at section 14 of FIG. 12; and

FIG. 15 is a cross sectional elevational view of surface 92 of FIG. 8.

### DETAILED DESCRIPTION

The following description is merely exemplary in nature and is not intended to limit the present disclosure, application, or uses. It should be understood that throughout the drawings, corresponding reference numerals indicate like or corresponding parts and features.

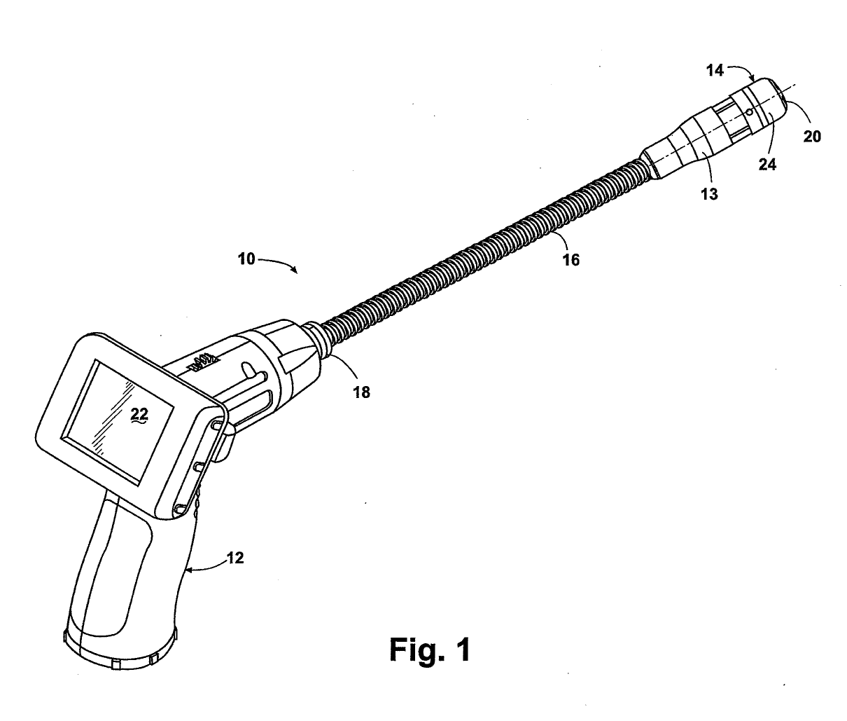

Referring to FIG. 1, a remote inspection device 10 can include a hand-held display housing 12 and an imager assembly 13 including an imager head sub-assembly 14, a flexible tube 16 allowing imager head sub-assembly 14 to be remotely and movably displaced with respect to display housing 12, and a housing connection sub-assembly 18 releasably connecting flexible tube 16 to display housing 12. Imager head sub-assembly 14 includes an image receiving end 20 adapted to receive and digitally send a viewed image from imager head sub-assembly 14 to an image view screen 22 provided with display housing 12. The image view screen 22 is adapted to present an image transferred by the imager head sub-assembly as a digital signal. An imager end cap 24 is provided to releasably engage the image receiving end 20 to imager assembly 13.

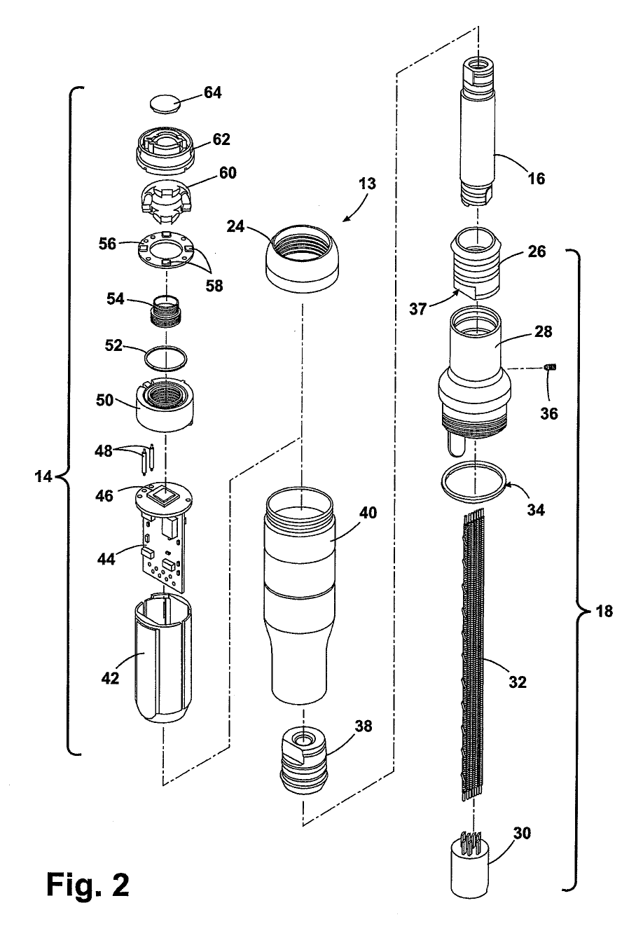

Referring to FIG. 2, housing connection sub-assembly 18 includes a first ferrule 26 which is slidably received and pressed into frictional engagement with a male connector 28. A multiple pin electrical connector 30 is provided which includes a plurality of pins which provide connection points for the multiple individual wires of a wiring harness 32 which is received through each of first ferrule 26 and male connector 28. A seal 34 such as an elastic O-ring is also provided to act as an environmental seal member between male connector 28 and display housing 12 (shown in FIG. 1). A fastener 36 such as a set screw is also provided to frictionally engage the multiple pin electrical connector 30 within male connector 28.

Wiring harness 32 provides multiple wires which pass through first ferrule 26 into a longitudinal cavity of flexible tube 16 and exit through a second ferrule 38 which is press fit into an imager body 40. Imager assembly 13 includes imager head sub-assembly 14 which is retained by imager end cap 24 threadably engaged to imager body 40. Imager head sub-assembly 14 includes second ferrule 38, imager body 40 and each of a circuit board retainer 42, a circuit board assembly 44 having an imager device 46 fixed thereto, a plurality of electrically conductive pins 48, a lens receiving unit 50, a gasket seal 52 such as an O-ring, a lens assembly 54, and a light source circuit board 56 having at least one and in at least one embodiment four (4) high intensity light emitting diodes (LEDs) 58 equidistantly spaced from each other in a circular pattern. A molded light dispersal unit or light pipe unit 60 is positioned proximate to (above as shown in FIG. 2) circuit board 56 to receive and diffuse light transmitted by LEDs 58. Light pipe unit 60 is held within a light pipe cap 62, which is also adapted to hold a sapphire window 64 which receives reflected light for focusing using a lens of lens assembly 54 onto imager device 46. Imager end cap 24 is threadably received on a free end of imager body 40 after the components of imager head sub-assembly 14 are installed. Wiring connections are also made between the individual wires of wiring harness 32 and circuit board assembly 44.

High intensity light emitting diodes (LEDs) 58 produce light from energy received through circuit board 56 to illuminate an area in a viewing range of lens assembly 54 and imager device 46. The illuminated image received by imager device 46 can be converted via circuit board assembly 44 to a digital signal and transferred via wiring harness 32 to the image view screen 22 of display housing 12 shown in FIG. 1. According to other embodiments, the illuminated image can also be converted to an analog signal.

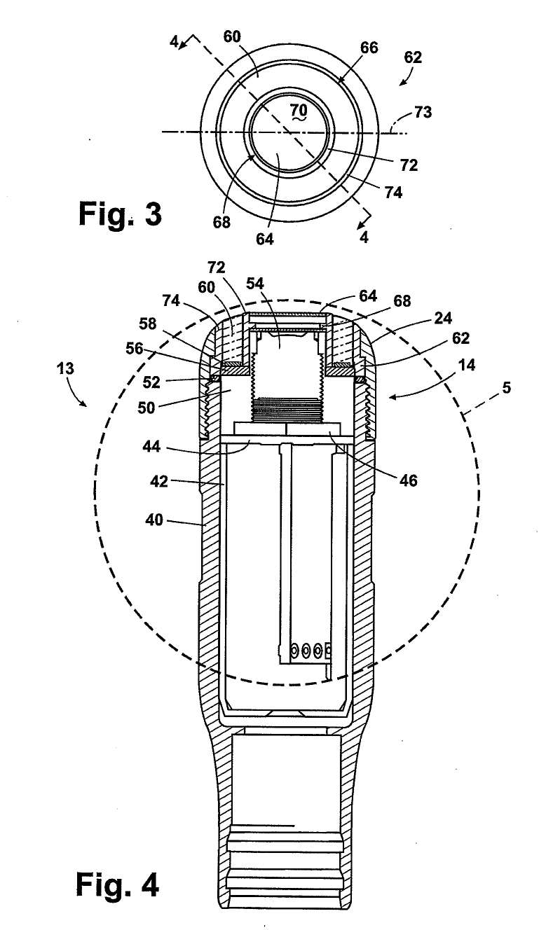

Referring to FIG. 3, sapphire window 64 can be centrally positioned within an interior wall defined by light pipe cap 62. Light pipe unit 60 is received in a circular shelf 66 formed in light pipe cap 62. Sapphire window 64 is supported in a counterbore 68 extending into a bore 70 of light pipe cap 62. Shelf 66 is defined between an inner wall 72 and an outer wall 74. Light is therefore transmitted throughout the donut or toroid shape of light pipe unit 60 and the reflected (image containing) light is received through sapphire window 64.

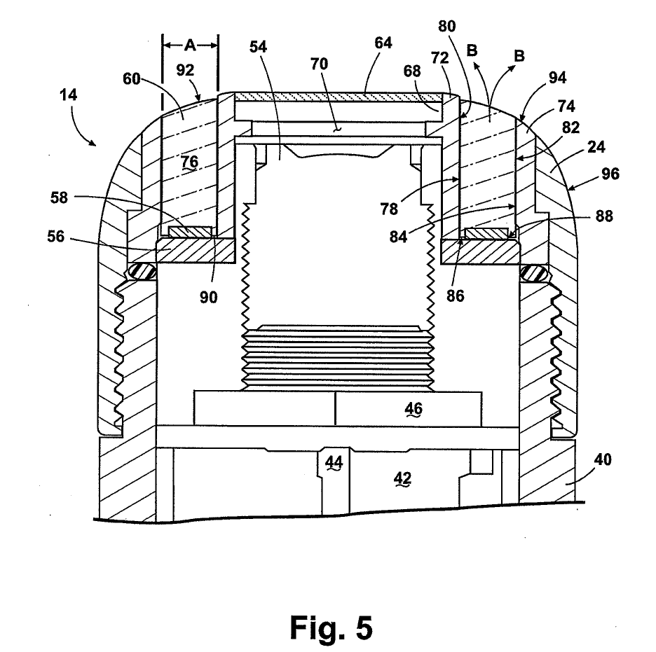

Referring to FIG. 4, an imager head sub-assembly 14 according to several embodiments provides a configuration having lens assembly 54 threadably engaged within lens receiving unit 50. Lens receiving unit 50 provides support for circuit board 56. Circuit board 56 in turn provides support for inner wall 72 of light pipe cap 62, while an interface between outer wall 74 of light pipe cap 62 and imager body 40 is sealed using gasket seal 52. As shown, the LEDs 58 are aligned on circuit board 56 to transmit light generated by the LEDs 58 through the body of light pipe unit 60 as light rays “B” shown in FIG. 5. Light transmitted by LEDs 58 and reflected by an object (not shown) and received through sapphire window 64 is digitally transmissible through lens assembly 54 using imager device 46 to circuit board assembly 44, which is retained at least partially within circuit board retainer 42.

Referring to FIG. 5, light pipe unit 60 includes a toroidal wall 76 which is received in shelf 66 of light pipe cap 62. Toroidal wall 76 has a dimensionally controlled width “A” which promotes contact between a first face 78 to an outward facing surface 80 of inner wall 72, and a second face 82 to an inward facing surface 84 of outer wall 74. Contact is maintained for first and second faces 78, 82 to minimize moisture/dirt intrusion. According to several embodiments contact made by first and second faces 78, 82 eliminates the need for a sealant or adhesive at these locations. An end face 86 of individual sections of toroidal wall 76 contacts an upper surface 88 of circuit board 56, and according to several embodiments a sealant layer 90 such as a silicone is applied at the interface between end faces 86 and upper surface 88. Toroidal wall 76 has a curved upper surface 92 whose geometry is adapted to closely match a curvature of an outer surface 94 of outer wall 74 which is also adapted to closely match a curvature of an outward facing surface 96 of imager end cap 24.

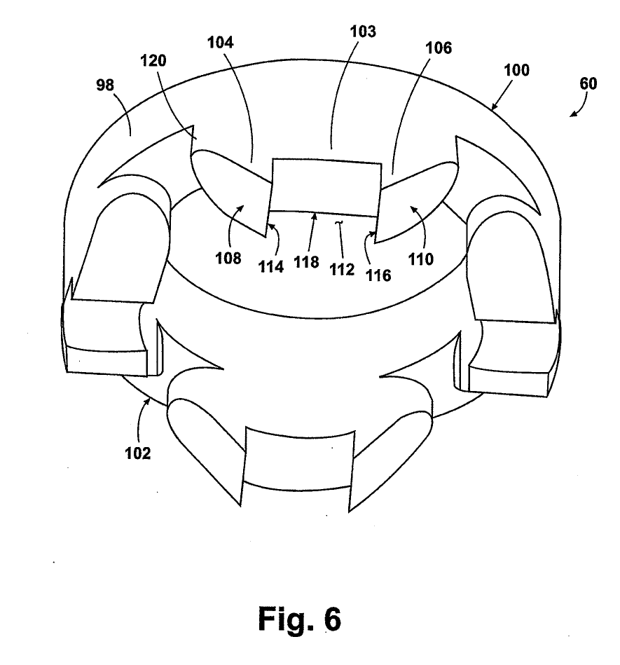

Referring to FIG. 6 and again to FIG. 5, light pipe unit 60 can be molded or formed from a polymeric material to create a tubular ring 98 having first and second opposed surfaces 100, 102. A plurality of raised portions 103 are created to match a quantity of LEDs 58. Each raised portion 103 includes first and second extending portions 104, 106, individually having a first and second curved end surface 108, 110 defining a free end of the first and second extending portions 104, 106 respectively. A slot 112 is created in each raised portion 103 adapted to allow one of the LEDs 58 to be received within the slot 112. Each slot 112 is defined by opposed first and second slot walls 114, 116, and a slot end wall 118. Each of the first and second extending portions 104, 106 can have a rounded end 120 which extends from second surface 102 to intersect either curved end surface 108 or 110. Light generated by each LED 58 enters the raised portion 103 through opposed slot walls 114, 116, and slot end wall 118. The geometry of curved end surfaces 108, 110 is adapted to maximize diffusion/transmission of light through raised portions 103 and tubular ring 98.

According to several embodiments, light pipe unit 60 can be constructed using a molding process such as injection or insert molding from a polymeric material to create a transparent body having tubular-shaped ring 98 and at least one raised portion 103 homogenously joined to the tubular ring 98. The at least one raised portion 103 includes a slot 112 created between opposed first and second extending portions 104, 106 having an end wall 118 and opposed first and second slot walls 114, 116 which can be oriented perpendicular to end wall 118. The rounded end face 108, 110 defines a free end of each of the first and second extending portions 104, 106 and face away from, or outward with respect to the tubular ring 98.

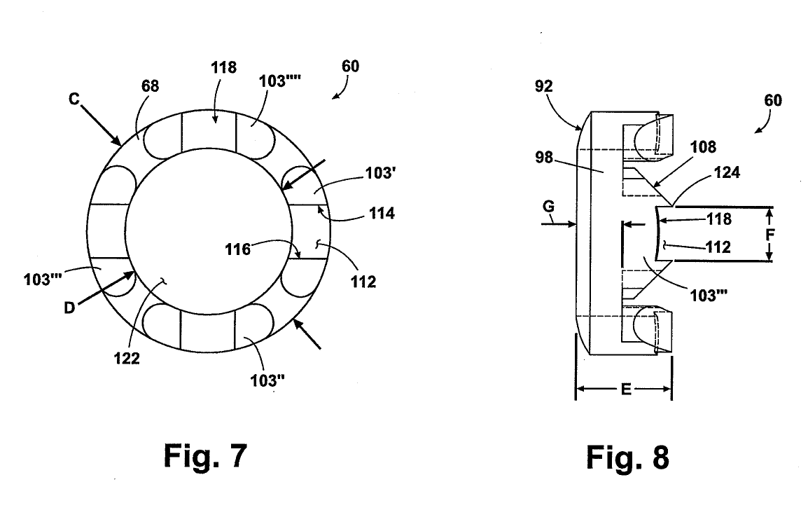

Referring to FIGS. 7 and 8, and again to FIG. 5, according to several embodiments, four (4) raised portions 103, identified as raised portions 103′, 103″, 103′″, and 103″″ are provided, corresponding to a quantity of four (4) LEDs 58. The four raised portions 103 each have their slots 112 equidistantly spaced from the slots 112 of proximate raised portions 103 (e.g.:, in the exemplary embodiment shown spaced at 90 degree increments). According to several embodiments, tubular ring 68 of light pipe unit 60 can have an outer diameter “C” and an inner diameter “D” defined by a through bore 122, and a total height “E”. According to several embodiments, outer diameter “C” can have a range of approximately 12.6 mm to 12.7 mm, inner diameter “D” can have a range of approximately 8.7 mm to 8.8 mm, and total height “E” can have a range of approximately 4.88 mm to 4.98 mm. Each slot 112 can have a width “F” having a range of approximately 2.81 mm to 2.91 mm, and tubular ring 98 can have a thickness “G” having a range of approximately 2.28 mm to 2.38 mm. The dimensions give herein are exemplary only and can vary at the discretion of the manufacturer.

Curved end surfaces 108, 110 can define a convex shaped surface have a radius of curvature. Slot end walls 118 can be substantially flat or according to several embodiments can define a convex shape facing away from tubular ring 98 having a radius of curvature. An apex 124 is created at the junction of either slot wall 114 or slot wall 116 with curved end surface 108 or 110, respectively, which can define a sharp corner adapted to minimize the surface area of light pipe unit 60 in contact with circuit board 56 and to maximize the surface areas of first and second curved end surfaces 108, 110 which receive and therefore diffuse light radially transmitted from LEDs 58 or reflected from upper surface 88 of circuit board 56.

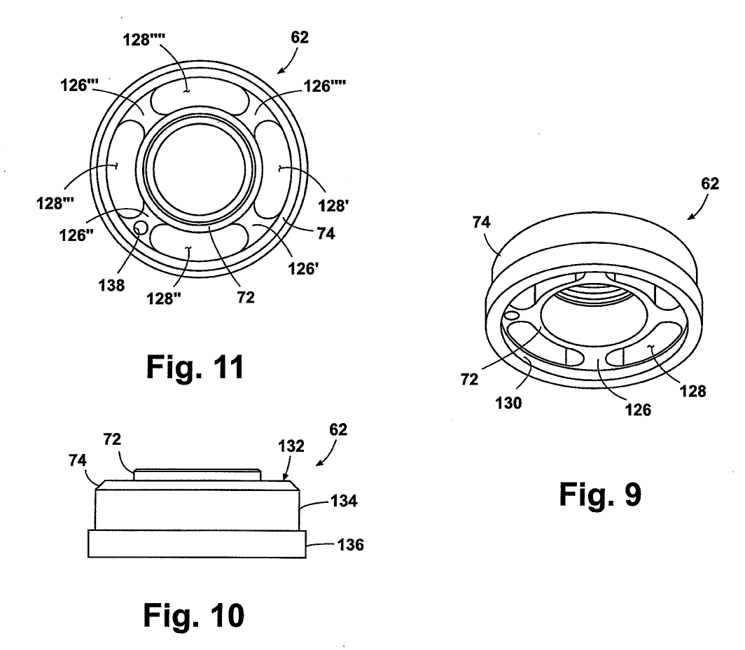

Referring to FIG. 9, an under or lower surface of light pipe cap 62 provides a plurality of lands 126 which structurally join the inner wall 72 to the outer wall 74. A plurality of curved bores 128 are provided between each of the lands 126. Curved bores 128 are provided to receive individual ones of the raised portions 103 of the light pipe unit 60. The geometry of curved bores 128 therefore closely matches the geometry of the individual raised portions 103 of the light pipe unit 60 so that a sealant is not required to be inserted between the individual raised portions 103 and the walls defined by the curved bores 128. An inner flange wall 130 is also created which has a diameter substantially matching that of an outer diameter of the light source circuit board 56 shown in reference to FIG. 5 when light pipe cap 62 is assembled together with light source circuit board 56.

Referring to FIG. 10, light pipe cap 62 further defines a wall end face 132 from which inner wall 72 extends beyond. A wall perimeter surface 134 is provided for outer wall 74. A flange surface 136 is provided as an outward facing surface opposed to inner flange wall 130 shown in FIG. 9.

Referring to FIG. 11, according to several embodiments light pipe cap 62 is adapted to provided for lands 126 shown as land 126′, 126″, 126′″ and 126″″. A quantity of four bores 128 is also provided shown as curved bores 128′, 128″, 128′″, and 128″″. Each of the curved bores 128 and the lands 126 are equidistantly spaced from each other. According to additional embodiments, at least one and in several embodiments a plurality of clearance apertures 138 can be provided in individual ones of the lands 126. In the examples shown, a single clearance aperture 138 is provided in lands 126″. Clearance apertures 138 are provided to receive an alignment pin (not shown) to rotationally orient the light pipe cap 62. Clearance apertures 138 can also be used for passage of electrical wires if necessary.

Referring to FIG. 12, a cap/circuit board assembly 140 shows an exemplary orientation of light pipe cap 62 with respect to the plurality of LEDs 58. Each of the LEDs 58 are oriented to centrally align with individual ones of the curved bores 128 of light pipe cap 62.

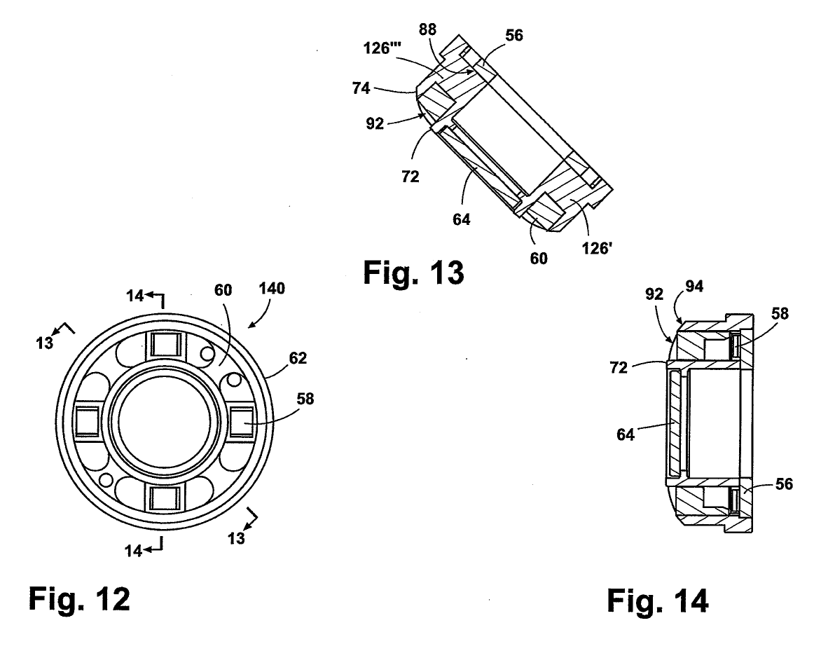

Referring to FIG. 13 and again to FIG. 9, the light pipe unit 60 is shown assembled into light pipe cap 62 together with sapphire window 64. Light source circuit board 56 is also shown positioned within the inner flange wall 130 defined by light pipe cap 62. Each of the curved upper surfaces 92 of light pipe cap 62 are shown positioned between the inner and outer walls 72, 74 of light pipe cap 62. The upper surface 88 of light source circuit board 56 abuts individual ones of the lands 126 in the assembled position of light source circuit board 56.

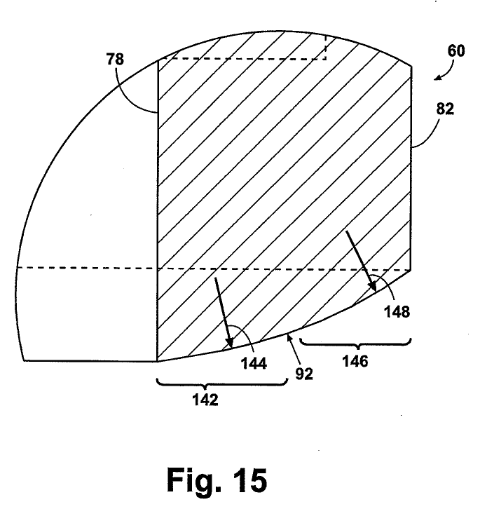

Referring to FIG. 14 and again to FIGS. 6-8, individual ones of the LEDs 58 are shown in their aligned positions between inner wall 72 and outer wall 74 so that light generated by the LEDs 58 can be transmitted through light pipe unit 60 through curved upper surfaces 92. Each of the raised portions 103 of the transparent light pipe unit 60 further includes a first apex 124 created at a junction of the first slot wall 114 and the first rounded end face 108 and a second apex 124 created at a junction of the second slot wall 116 and the second rounded end face 110. The first and second apexes 124 are positioned in contact with the circuit board 56 with one of the light emitting diodes 58 positioned within the slot 112. According to other embodiments, the apexes 124 can be positioned proximate to, but not in direct contact with the circuit board 56.

Referring to FIG. 15, curved upper surface 92 according to several embodiments can be defined by two or more individual curved surface portions. In the exemplary embodiment shown, a first curve portion 142 has a first radius of curvature 144 and a second curve portion 146 has a second radius of curvature 148. First and second radius of curvatures 144, 148 can be equal or different from each other. The difference in curvature between the first and second curve portion 142, 146 can be optimized to maximize the focal length of the light transmitted through light pipe unit 60 to a distance selected by the manufacturer.

Light pipe units 60 of the present disclosure provide several advantages. By creating the slot 112 between first and second slot walls 112, 114, the light pipe unit 60 can be positioned to provide transparent material in contact with, or in close proximity to the exposed surfaces of the LEDs 58. This permits a greater amount of light from the LEDs 58 to be captured and transmitted via the light pipe unit 60. By creating apexes where the first and second slot walls 112, 114 meet the curved end surfaces 108, 110, contact between the light pipe unit 60 and the circuit board can be minimized. The curved end surfaces 108, 110 also promote reflection of light emitted from the LEDs 58 that is not parallel or co-axial with the raised portions 103 to be redirected outwardly from the light pipe unit 60, increasing the total light emission. Using two or more curve portions 142, 146 each having a different radius of curvature further promotes transmission of reflected light from the LEDs 58. By sizing the raised portions 103 to slidably or frictionally fit against the walls defined within the curved bores 128 of the light pipe cap 62, these spaces or gaps can be minimized or eliminated, eliminating the need for a moisture or dirt sealant in these spaces.

What is claimed is:

1. A light dispersal unit for a video imaging device, comprising:
a transparent body having:
a tubular ring; and
at least one raised portion homogenously joined to the tubular ring, the at least one raised portion including:
a slot created between opposed first and second extending portions having an end wall and opposed first and second slot walls;
and
a rounded end face defining a free end of each of the first and second extending portions facing away from the tubular ring.

2. The light dispersal unit of claim 1, further including a rounded end of each of the first and second extending portions positioned opposite to the slot and extending between the tubular ring and the rounded end face.

3. The light dispersal unit of claim 1, wherein the tubular ring further includes parallel first and second opposed surfaces with the at least one raised portion homogenously connected to the second surface.

4. The light dispersal unit of claim 1, wherein the at least one raised portion comprises four equidistantly spaced raised portions.

5. The light dispersal unit of claim 1, wherein the rounded end face further includes at least two curved portions each having a radius of curvature.

6. The light dispersal unit of claim 1, further including a first apex created at a junction of the first slot wall and the first rounded end face and a second apex created at a junction of the second slot wall and the second rounded end face.

7. A light dispersal unit for a video imaging device, comprising:
a transparent polymeric body including:
a tubular ring having an outer diameter and a through bore defining an inner diameter; and
four equidistantly spaced raised portions homogenously joined to the tubular ring and having a semi-circular shape corresponding to the outer and inner diameters of the tubular ring, the raised portions each including:
a slot created between opposed first and second extending portions having an end wall and opposed first and second slot walls;
and
a rounded end face defining a free end of each of the first and second extending portions facing away from the tubular ring, the rounded end face including at least two curved portions each having a different radius of curvature.

8. The light dispersal unit of claim 7, wherein the tubular ring further includes parallel opposed first and second surfaces with the raised portions homogenously connected to the second surface.

9. The light dispersal unit of claim 8, further including a curved surface joining the first surface to an outer wall defined by the outer diameter.

10. The light dispersal unit of claim 7, further including a first apex created at a junction of the first slot wall and the first rounded end face and a second apex created at a junction of the second slot wall and the second rounded end face.

11. A video imaging device, comprising:
a circuit board having a light emitting diode connected to the circuit board;
a transparent light pipe having:
a tubular ring; and
at least one raised portion homogenously joined to the tubular ring, the at least one raised portion including:
a slot created between opposed first and second extending portions having an end wall and opposed first and second slot walls;
and
a rounded end face defining a free end of each of the first and second extending portions facing away from the tubular ring; and
a light pipe cap adapted to retain the circuit board and the light pipe having the slot of the light pipe aligned with the light emitting diode so that light emitted by the light emitting diode is received at the slot and by the rounded end face of each of the first and second extending portions.

12. The video imaging device of claim 11, wherein the rounded end face includes at least two curved portions each having a different radius of curvature.

13. The video imaging device of claim 11, further including a first apex created at a junction of the first slot wall and the first rounded end face and a second apex created at a junction of the second slot wall and the second rounded end face, the first and second apexes being in contact with the circuit board when an assembly of the circuit board, the light pipe and the light pipe cap is created.

14. The video imaging device of claim 11, wherein the light pipe cap further includes:
an inner wall and an outer wall, the at least one raised portion being received between the inner wall and the outer wall with a friction fit.

15. The video imaging device of claim 14, wherein the tubular ring includes a first side having a curved surface which meets the outer wall of the light pipe cap, and an opposed second side having the at least one raised portion extending therefrom.

16. A video imaging device, comprising:
a circuit board having four light emitting diodes connected to the circuit board equidistantly spaced from each other;
a transparent light pipe including:
a tubular ring having an outer diameter and a through bore defining an inner diameter; and
four equidistantly spaced raised portions homogenously joined to the tubular ring and having a semi-circular shape corresponding to the outer and inner diameters of the tubular ring, the raised portions each including:
a slot created between opposed first and second extending portions having an end wall and opposed first and second slot walls;
and
a rounded end face defining a free end of each of the first and second extending portions facing away from the tubular ring, the rounded end face including at least two curved portions each having a different radius of curvature; and
a light pipe cap adapted to retain the circuit board and the light pipe having each slot of the light pipe aligned with one of the light emitting diodes so that light emitted by each light emitting diode is received at the slot and by the rounded end face of each of the first and second extending portions.

17. The video imaging device of claim 16, wherein the light pipe cap further includes four curved bores each sized to slidingly receive one of the raised portions of the light pipe.

18. The video imaging device of claim 17, wherein the light pipe cap further includes:
an inner wall;
an outer wall; and
four lands each homogenously connected to both the inner wall and the outer wall between proximate ones of the four curved bores.

19. The video imaging device of claim 16, wherein each of the raised portions of the transparent light pipe further includes a first apex created at a junction of the first slot wall and the first rounded end face and a second apex created at a junction of the second slot wall and the second rounded end face, the first and second apexes being positioned in contact with the circuit board with one of the light emitting diodes positioned within the slot.

20. The video imaging device of claim 16, further comprising:
an imager body adapted to receive the circuit board, the light pipe and the light pipe cap;
a flexible tube connected to the imager body adapted to contain a wiring harness connected to the circuit board; and
a display housing connected to the flexible tube opposite to the imager body, the display housing having a video image view screen adapted to display an image illuminated by the light emitted by the light emitting diodes digitally transmitted from the circuit board through the wiring harness.
